(19) United States
(12) Patent Application Publication
(10) Pub. No.: US 2016/0012859 A1
(43) Pub. Date: Jan. 14, 2016

(54) SYSTEM AND METHOD FOR GENERATING AND USING SPATIAL AND TEMPORAL METADATA

(71) Applicant: Hypershow Ltd., Seattle, WA (US)

(72) Inventors: Timothy D. Harader, Seattle, WA (US); Daniel T. Gehred, Portland, OR (US); Peter N. Brady, Seattle, WA (US)

(21) Appl. No.: 14/861,791

(22) Filed: Sep. 22, 2015

Related U.S. Application Data
(63) Continuation of application No. PCT/US2015/010348, filed on Jan. 6, 2015.
(60) Provisional application No. 61/924,645, filed on Jan. 7, 2014.

(51) Int. Cl. G11B 27/34; G11B 27/02; G06K 9/00

(52) U.S. Cl. CPC G11B 27/34; G06K 9/00744; G11B 27/02

(57) ABSTRACT

A computer-implemented method is provided that includes: obtaining, by a configured computing system, a plurality of video frames; determining, by the configured computing system, one of the plurality of video frames that includes an element of interest; creating, by the configured computing system, a logical object that represents a visual, sonic, or conceptual element of interest in the video frames; creating, by the configured computing system, a target that represents a visual outline or other presence indicator of an element of interest in the one video frame; associating, by the configured computing system, a metadata trait with logical object; associating, by the configured computing system, a logical object with a target that includes information for use upon later user selection of the target during presentation of the one video frame; and storing, by the configured computing system, indications of the created target and associated logical object and metadata traits, to enable use of the information included in the logical object upon the later user selection of the target.

### BACKGROUND

1. Technical Field

The present disclosure relates generally to audiovisual content editing and, more particularly, to embedding and editing metadata objects within audiovisual content to create interactive, customizable content.

2. Description of the Related Art

The World Wide Web is built on the concept of non-linear navigation that allows users to view text, graphics, and content interactively. From within a web page users can conveniently jump to other areas of that same page, load new information into that page, or even jump to any other page for which they have access permissions on the Internet. This model of nonlinear navigation, also known as a “hyperlinking,” is pervasive. Without it, the Web could not exist. The fact that this amazing capability is an unremarkable part of our daily use of the Internet is a testament to how non-linearity is built into the fabric of the Web.

The method behind hyperlinking on a web page is straightforward at a high level. The user clicks or taps on some area of the device screen. The device OS captures the X,Y coordinates of the screen location of the interaction and passes those values to a web browser or other application. The browser or application compares the coordinates of the interaction to the coordinates of known “hotspots” in the visual representation of the user interface as defined in the underlying programming code of the UI. If there is a hotspot region intersecting the X,Y coordinates of the user interaction, then the browser or application takes the action, for example navigation, state transitions, animations, etc., that has been specified in the hyperlink for that hotspot. In its most common form, the action consists of loading new information into the browser or application UI from a local or remote dataset or page view.

Support for the creation of hotspots and their corresponding hyperlinks within a webpage or application is as ubiquitous as the use of hyperlinking itself. A plethora of platforms, toolsets, devices, and operating systems allow content creators to easily program content for interactivity using a variety of methods and programming languages; HTML, CSS, and JS, and native device programming environments are currently the most popular methods.

It is commonly understood that the concept of hyperlinking applies not only to text and static images but also to animation and video. The terms “Hypermedia” and “Hypervideo” have been widely used to denote hyperlinks that are triggered via hotspots overlaid on animation or video content. These hotspots can be represented by buttons or other visible indicators that appear overlaid on the video image. Further, such selectable areas may change over time in synchronization with certain frames of the presentation or even specific areas of the image as they may change over time. This type of interactivity, although more complex, is simply the equivalent of hyperlinking from a web page. In other words, a hotspot is defined somewhere on the screen, and upon clicking the hotspot the user is hyperlinked to a specific action or resource. This scenario is also used when such navigation using hotspots forwards the user to another position in the current video presentation or to a position in another video presentation.

Persons familiar in the relevant art recognize that there are a multitude of generally available methods for creating such hotspots over video content in popular computer and device operating systems and their accompanying programming platforms, such as Microsoft Windows, Apple Mac OS and iOS, and Linux/Android. These capabilities are also available in popular cross-OS, cross-device, multimedia platforms such as Adobe Flash, Microsoft Silverlight, and Oracle's Java.

The creation and consumption of hyperlinked hotspots over animation and video content has been the topic of several previous patents. In U.S. Pat. No. 5,204,947, Bernstein et al. describe a system for linking between documents (including motion video files) via “Link Markers” placed in-line in a document and visible in various forms or even invisible.

In U.S. Pat. No. 6,074,104, McCue describes the creation and use of “image maps” over video as hotspots with associated hyperlinks that initiate the action specified in a URL.

In U.S. Pat. No. 5,422,674, Hooper et al. describe an interactive video system employing background images and images overlaid on video as buttons to trigger interactivity. Similarly, in U.S. Pat. No. 5,524,195, Clanton et al. describe a video graphical user interface wherein the user can initiate playback of specific content by touching (clicking on) graphical elements via a virtual “studio back lot” video environment.

As explained above, hotspots provide the user a way to trigger the action specified by the underlying hyperlink. A hyperlink is a basic instruction set that links a hotspot or other user or application-triggered selection to a dataset via a particular action. A hyperlink can be static, as in a webpage where the hyperlink consists of a single URL telling the application to load a specific resource via its specified protocol and address, or a hyperlink can be dynamic, where the instructions for loading the resource are stored in a lookup table or mapping dataset where the link can change based on application logic.

With regard to associating hyperlinks to hotspots in video presentations, there is a wealth of prior approaches utilizing various systems and methods. In U.S. Pat. No. 5,539,871, Gibson et al. describe the association of a “data set” with an animated graphical element via an “additional graphic element” or “button” or “other graphic indicator.” When the end user “effectively selects” (i.e., hyperlinks to) one of these visual elements (aka hotspots) a “data set” may be presented to the user. The '871 patent does not provide any detail on the mechanism for the “effective selection” and claims only a “means for retrieving and presenting said at least one data set in response to an input from said data processing system user”; but persons familiar in the relevant art will recognize this mechanism as a hyperlink to the associated “data set.”

In U.S. Pat. No. 5,596,705, Reimer et al. describe a similar system and method whereby movie information relevant to the currently viewed frame may be retrieved via text queries in a selectable menu UI. In this scenario, items appearing in the menu can be considered hotspots, and the underlying hyperlink retrieves the relevant data from a database table.

In U.S. Pat. No. 5,684,715, Palmer et al. describe “an interactive video system by which an operator is able to select an object moving in a video sequence and by which the interactive video system is notified which object was selected so as to take appropriate action.” The text further details the creation and usage of “object descriptors” (i.e., hotspots) that may resize and move on screen in tandem with a predetermined underlying OnScreen image element. When an “object descriptor” is selected by an end-user, an associated “action map containing a list of actions” (i.e., a hyperlink) in combination with a means for “activating a corresponding action in said action map” are initiated.

In U.S. Pat. No. 7,804,506, Bates et al. describe a “system and method for tracking an object in a video and linking information thereto.” The text details a method for selecting relevant pixels in a video frame and automatically tracking them as a “pixel object.” The resulting range of pixels makes up a “pixel object file which identifies the coordinates of the selected pixel object in each frame” (i.e., a hotspot). “The pixel object file is linked to a data object file which links the selected pixel objects to data objects.” In other words, the pixel object file (hotspot) is linked via the object data file (i.e., the hyperlink) to the data object (the associated data set).

In U.S. Pat. No. 6,496,981, Wistendahl et al. describe a similar system for “generating the object mapping data for media content” that creates hotspots in the form of outlines of underlying images in the video. These “object maps” are then associated with “linkages provided through an associated interactive media program from the objects specified by the object mapping data to interactive functions to be performed upon selection of the objects in the display.” In other words, the “object maps” or hotspots have associated hyperlinks which direct the interactive media program logic to perform an action.

Lastly, in U.S. Pat. No. 8,065,615, Murray et al. provide a method of retrieving information associated with an object present in a media stream. In this method, “A link is associated between the user-selectable region and the information associated with the object to identify the location where information associated with the object is stored.” Further, “Once the user-selectable region is selected, the information associated with the object is then displayed.” Clearly, the method for achieving the interactivity is a hotspot (the “user-selectable region”) and a hyperlink (the “link”) which instructs the program logic to display the associated dataset (the “information associated with the object”).

All of the above systems and methods generally describe the creation and consumption of associated data and content via interaction with hotspots and hyperlinks. Regardless of the diverse terminology used, they take the same well-established approach that has been used ubiquitously on the Web and in software applications for hyperlinking user interface elements to available resources. Accordingly, it is essential, but not obvious, to point out in the above approaches that:

a.) Hyperlinked data sets and resources (e.g., URLs) are directly bound to their corresponding hotspots (which may represent underlying image elements on the video screen); and

b.) No logical object exists between the hotspot and its associated dataset or resources; only a hyperlinking mechanism exists.

The relationships of these components are shown in FIG. 1. A hotspot 100 is related directly to a hyperlink 110, which is related directly to a dataset 120. When the hotspot is activated by a user, the application logic determines what hyperlink is associated and retrieves the resource or dataset, then performs the action 130 determined by the application logic 140. This deficiency in these prior approaches renders such systems and methods inflexible in actual use. Because the hotspot is directly related to the resource or dataset (via the hyperlink), there is no reasonable, user-friendly or programmatic way to re-associate a dataset or resources to a different hotspot, or to associate a dataset or resources to elements of the underlying presentation that are not represented by hotspots.

### BRIEF SUMMARY

In accordance with one aspect of the present disclosure, a computer-implemented method is provided that includes: obtaining, by a configured computing system, a plurality of video frames; determining, by the configured computing system, one of the plurality of video frames that includes an element of interest; creating, by the configured computing system, a logical object that represents a visual, sonic, or conceptual element of interest in the video frames; creating, by the configured computing system, a target that represents a visual outline or other presence indicator of an element of interest in the one video frame; associating, by the configured computing system, a metadata trait with logical object; associating, by the configured computing system, a logical object with a target that includes information for use upon later user selection of the target during presentation of the one video frame; and storing, by the configured computing system, indications of the created target and associated logical object and metadata traits, to enable use of the information included in the logical object upon the later user selection of the target.

In accordance with another aspect of the present disclosure, a method is provided that includes: receiving audiovisual content, the content including indexed video frames; associating a logical object with an element in the received content; identifying at least one video frame associated with the element; creating a target within each identified video frame, the target configured to represent a visual outline or other presence indicator of the element in each identified video frame; associating a logical object with the target or with an identified video frame; and storing a reference to each associated logical object in an object dataset.

In accordance with yet another aspect of the present disclosure, a computing system is provided that includes a processor; and a module that is configured to, when executed by the at least one processor: receive audiovisual content, the content including indexed video frames; associate a logical object with an element in the received content; identify video frames associated with the element; create a target within each identified video frame, the target configured to represent a visual outline or other presence indicator of the element in each identified video frame; associate a logical object with the target or with an identified video frame; and store a reference to each associated logical object and the target in an object dataset.

In accordance with still yet another aspect of the present disclosure, a non-transitory computer-readable storage medium whose contents configure a computing system to perform a method is provided. The method includes: managing a library of logical objects, the managing including: receiving a request to update at least one logical object with supplied information; and associating the supplied information with the at least one logical object; managing a library of object traits, the managing including: receiving a request to update at least one object trait with supplied information; and associating the supplied information with the at least one object trait; managing a library of metadata, the managing including: receiving metadata; receiving a request to associate the received metadata with at least one logical object; and associating the received metadata with the at least one logical object; managing a library of targets, the managing including: receiving a request to associate target information with at least one logical object, the target information including at least one identified region in at least one indexed video frame or an identified off-screen target and the index of each at least one indexed video frame; associating the target information with the at least one logical object; correlating the contents of the logical objects library, object traits library, metadata library and targets library; and outputting the correlated contents to an object dataset.

As will be readily appreciated from the foregoing, the addition of a logical Object representing the logical existence of the underlying element in the video provides a more flexible and functional capability for interactive media applications.

### BRIEF DESCRIPTION OF THE SEVERAL VIEWS OF THE DRAWINGS

The foregoing and other features and advantages of the present disclosure will be more readily appreciated as the same become better understood from the following detailed description when taken in conjunction with the following drawings, wherein:

FIG. 1 is an illustration of the relationships among hotspots, hyperlinks, and datasets in typical hypermedia and hypervideo interactivity;

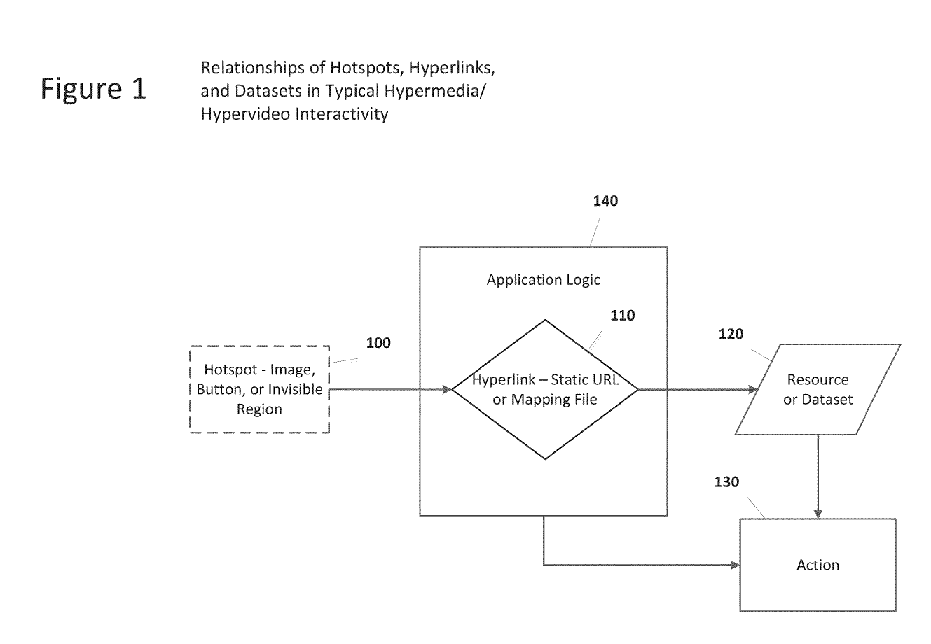

FIG. 2 is an illustration of relationships among hotspots, hyperlinks, objects, and datasets in accordance with the present disclosure;

FIG. 3 illustrates the relationship of the various logical elements described in the present disclosure;

FIG. 4 illustrates typical Tools and Assets configurations for Object Dataset creation and management in accordance with the present disclosure;

FIG. 5 illustrates typical functionality and workspace layout of a tool in accordance with the present disclosure;

FIG. 6 illustrates the association of a video with a project in accordance with the present disclosure;

FIG. 7 illustrates the user interface and data structure for creation of objects in accordance with the present disclosure;

FIG. 8 illustrates use of the tool to identify targets in a video frame in accordance with the present disclosure;

FIG. 9 illustrates use of the tool in connection with temporal traits in accordance with the present disclosure;

FIG. 10 illustrates the relational structure of the Object Dataset in accordance with the present disclosure;

FIG. 11 illustrates use of the tool in spanning video frames in accordance with the present disclosure;

FIG. 12 illustrates the function of the Object Dataset in Spanning Targets and Traits.

FIG. 13 illustrates the application hierarchy of an API and Object Dataset in accordance with the present disclosure; and

FIG. 14 illustrates the information architecture for an end-user consumption of the Object Dataset in accordance with the present disclosure.

### DETAILED DESCRIPTION

In the following description, certain specific details are set forth in order to provide a thorough understanding of various disclosed embodiments. However, one skilled in the relevant scientific techniques will recognize that embodiments may be practiced without one or more of these specific details, or with other methods, components, materials, etc. In other instances, well-known structures or components or both associated with streaming video content, cinematography, video editing and display, metadata creation, and hyperlinking have not been shown or described in order to avoid unnecessarily obscuring descriptions of the embodiments.

Unless the context requires otherwise, throughout the specification and claims that follow, the word “comprise” and variations thereof, such as “comprises” and “comprising” are to be construed in an open inclusive sense, that is, as “including, but not limited to.” The foregoing applies equally to the words “including” and “having.”

Reference throughout this description to “one embodiment” or “an embodiment” means that a particular feature, structure, or characteristic described in connection with the embodiment is included in at least one embodiment. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments. For ease of reference, similar structures and features will be illustrated and described using the same reference number.

Generally, the present disclosure is directed to a computer-implemented method for audiovisual content editing. In the method and the related system for implementing the method, the editing of the audio visual content includes embedding and editing metadata objects within the audiovisual content to create interactive, customizable content.

In a representative embodiment described in more detail below, the method includes receiving, by a configured computing system, at least one video frame, determining, by the configured computing system, an element of interest in the at least one video frame, creating a logical object to represent the element of interest, assigning permanent and temporal descriptive traits from a prepopulated metadata library of permanent and temporal descriptive traits to the logical object, creating, by the configured computing system, a target that represents an instance of the element of interest in the at least one video frame, associating, by the configured computing system, the logical object with the target or the at least one video frame by using a logical link, and storing, by the configured computing system, the logical object, the logical link, and the target to enable use of the assigned traits of the logical object upon a later user selection of the target.

It is to be understood that the determining the element of interest in the at least one video frame and the creating of the target are performed based at least in part on human input. In addition, the determining of the element of interest in the at least one video frame and the creating of the target are performed in an automated manner without human input. As described more fully below in connection with the figures, to facilitate interaction with a human user, the creating the target further can include creating a target that represents a visual outline of the element of interest in the at least one video frame.

The computer-implemented method also includes creating the library of permanent and temporal descriptive traits to be associated with the logical object. The determining of the element of interest in the at least one video frame further includes determining the element of interest in multiple video frames, and wherein the creating of the target is performed for each of the determined multiple video frames, and wherein the logical object is associated with each created target.

After the storing is completed, the method includes utilization by presenting the at least one video frame to a first user, receiving an indication of a selection by the first user of a portion of the at least one video frame that corresponds to the target, retrieving information included in the logical object associated with the target, and, in response to the selection by the first user, performing one or more additional automated operations based on the retrieved information.

A computing system is provided for implementing the foregoing method and the additional method steps described below, the system including a processor; and a module that is configured to, when executed by the processor receive audiovisual content, the received content including indexed video frames, associate a logical object with an element in at least one video frame of the received content, identify video frames associated with the element, create a target within each identified video frame, the target configured to represent an instance of the element in each identified video frame, associate a logical object with the target or with an identified video frame; and store a reference to each associated logical object and the target in an object dataset. Ideally, the logical object is configured to identify at least one characteristic of its associated element.

In another implementation, a non-transitory computer-readable storage medium whose contents configure a computing system to perform a method is provided. The method includes managing a library of logical objects, the managing including receiving a request to update at least one logical object with supplied information, and associating the supplied information with the at least one logical object. The method further includes managing a library of object traits, the managing including receiving a request to update at least one object trait with supplied information, and associating the supplied information with the at least one object trait. Also included is managing a library of metadata, the managing including receiving metadata, receiving a request to associate the received metadata with at least one logical object, and associating the received metadata with the at least one logical object, managing a library of targets, the managing including receiving a request to associate target information with the at least one logical object, the target information including at least one identified region in at least one indexed video frame and an index of each at least one indexed video frame. The method further includes associating the target information with the at least one logical object, correlating contents of the logical objects library, object traits library, metadata library and targets library; and outputting the correlated contents to an object dataset. The foregoing is then available to a user to edit content for desired viewing on a display device.

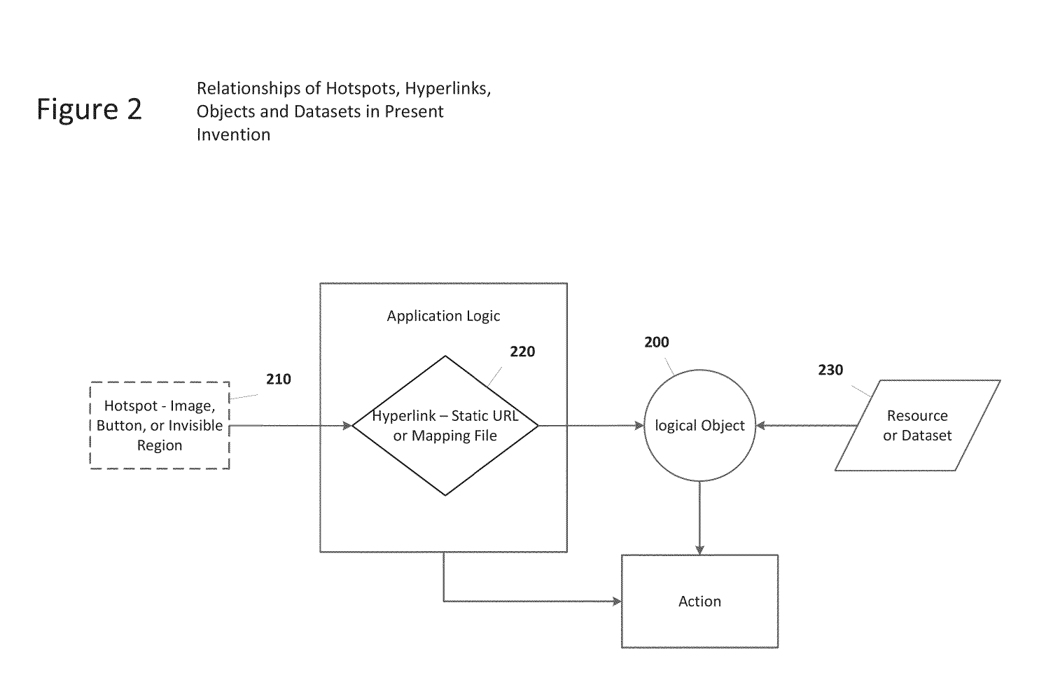

Referring next to the figures, in the disclosed implementations the disadvantages of prior approaches are overcome through the use of a logical Object representing the logical existence of the underlying element in the video. This provides a more flexible and functional capability for interactive media applications. Referring initially to FIG. 2, with the addition of the logical Object 200, the relationship between the hotspot 210 and the hyperlinking mechanism 220 are abstracted from the Resource or Dataset 230 by the logical Object such that changes can be made to either the hotspot or hyperlink, or to the resource or dataset, without any direct effect. Further, if any of the hotspot, hyperlink, or resource/dataset are erased, the logical Object continues to represent the existence of the underlying element in the video. As detailed below, it is the specific combination of hotspots (termed “Targets”), logical objects (termed “Objects”), and datasets (termed “Traits”) that enable the practical application of “Object-Based Interactivity” for advanced interactive media experiences.

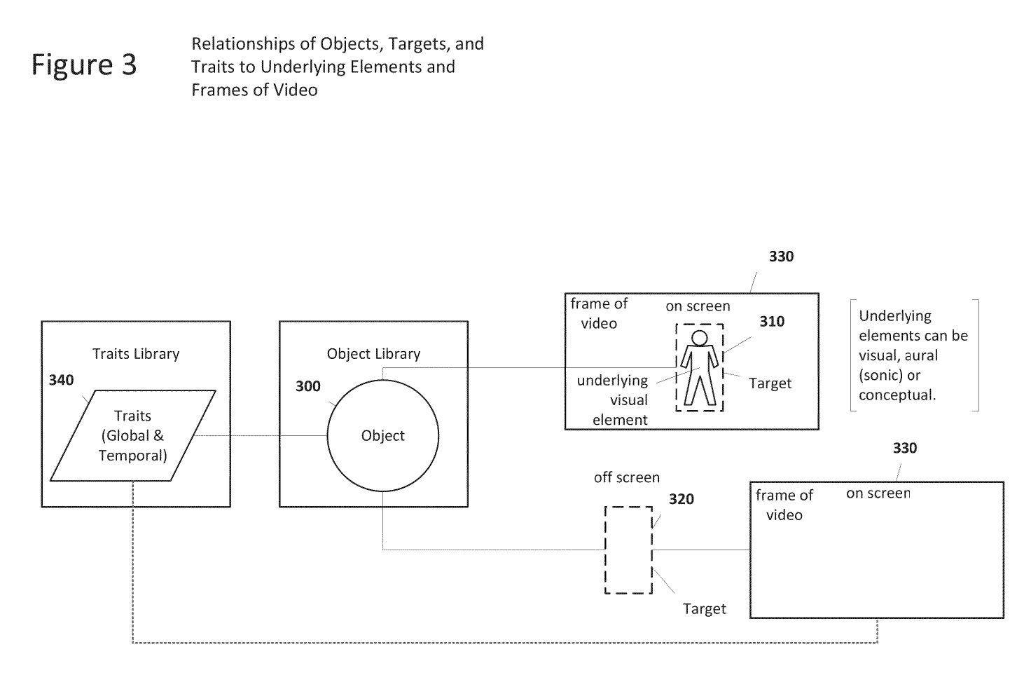

The system and method of the present disclosure utilize a unique combination of components—Targets, Objects, and Traits—to enable “Object-Based Interactivity” in audio-visual media experiences. Object-Based Interactivity is the concept of creating logical Objects to represent visual, sonic (aural), or conceptual elements existing in a frame of video. In Object-Based Interactivity, each logical Object is associated with spatial and/or temporal Targets, representing the existence of the Object within a frame of video. As shown in FIG. 3, Objects 300 can be associated with on screen Targets 310 or with off screen Targets 320 that are associated with a specific frame 330 of the video. Each Object carries global and temporal metadata Traits 340 that describe the permanent characteristics of the Object 300 as well as any temporary characteristics of the Object 300 at a given point in time.

The specific combination of Targets 310, 320, Objects 300, and Traits 340 within Object-Based Interactivity is what enables advanced interactive experiences to be available while viewing audio-visual presentations. The spatial or temporal boundary of each Target 310, 320 defines the presence of the Object 300. It may be visually present in the frame 330, off screen, or not present. The Object 300 carries its own Traits 340 that inform the logic of the application presenting the user experience so that unique interactivity can be triggered based on the specific Traits 340 of the Object 300 at any time.

Object-Based Interactivity enables advanced content experiences, including:

Conveniently viewing the relevant Traits 340 of an Object 300 by simply tapping/clicking on the Object's Target 310, 320.

Exploring or Purchasing elements represented in the video through Objects 300, like props, costumes, music, etc.

Non-linear navigation through the content, including the ability to follow multiple story trees.

Dynamic Object replacement—swapping out one Object 300 or its underlying visual or aural element(s) or both in the presentation for another based on user preferences, actions, or other dynamic or pre-determined triggers.

Personalized versions of the content, including story plot changes based on user actions or settings and versions automatically edited to comply with legal requirements or personal preferences.

Gamification of content—for example, Object-Based trivia questions, scavenger hunts, and other interactive games.

Object-Based Interactivity requires a system for creation and consumption of Objects 300, Targets 310, 320, and Traits 340, and a method defining the relation of the various created components and how they necessarily interact to deliver the advanced interactive media experiences. The resulting body of data that defines and describes the Objects 300, Targets 310, 320, Traits 340, their relationships, and other useful related data is called the Object Dataset.

The system for creating and using the Object Dataset is generally bifurcated into two parts: Creation of the Object Dataset and consumption or usage of the Object Dataset.

### Creation:

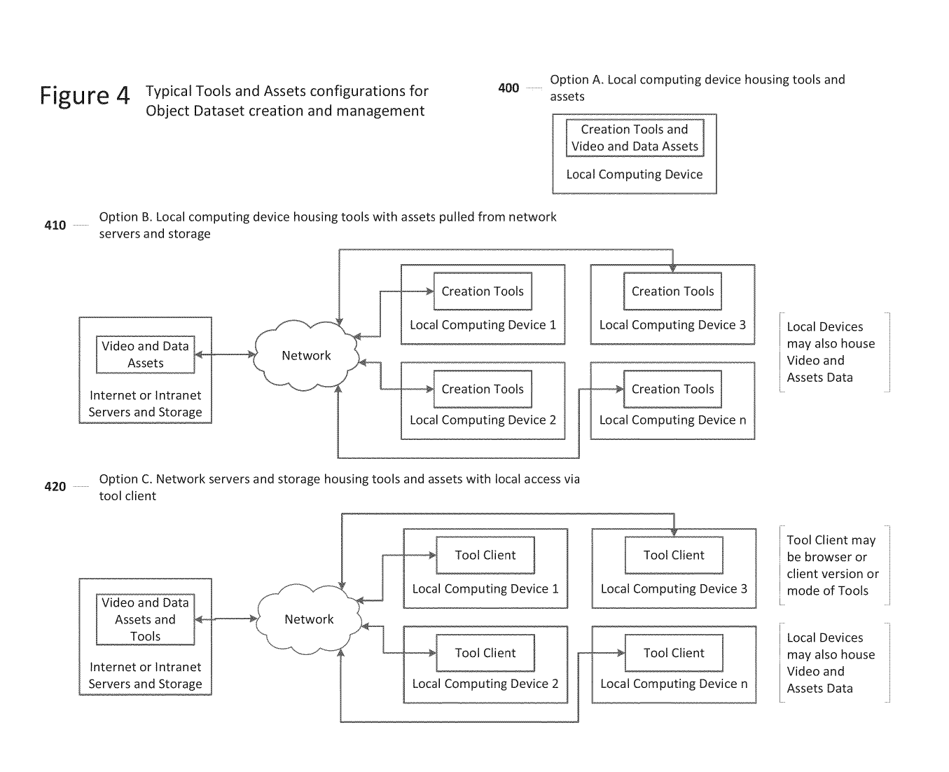

The following description is presented in conjunction with FIGS. 4-12. Object Dataset creation and ongoing management is achieved through a software application tool that can be local, distributed, or any combination. The various configurations accommodate the varied workflow needs of the content creation industry. One embodiment of the present disclosure is a stand-alone local application on a computing device 400 local to the user. All work is done on the device 400 with no connection to network-delivered resources. Another aspect of the present disclosure is a local computing device 410 configured to network a single or multiple instances of the application running on devices with network-delivered video and data assets. In this configuration, users can share assets. Also, local versions of the assets may exist on each device. Another embodiment 420 of the present disclosure is configured to network single or multiple instances of a client version or mode of the tool to network servers and assets. This configuration relies more heavily on network resources so that lower-capability devices and a higher level of distributed work may be utilized. Persons skilled in the relevant art will recognize that other embodiments may be configured for specific workflow requirements of the user.

Regardless of the embodiment of the creation tool configuration, the workflow and user interface for creating and managing the Object Dataset within the scope of the present disclosure is similar.

### The Workspace:

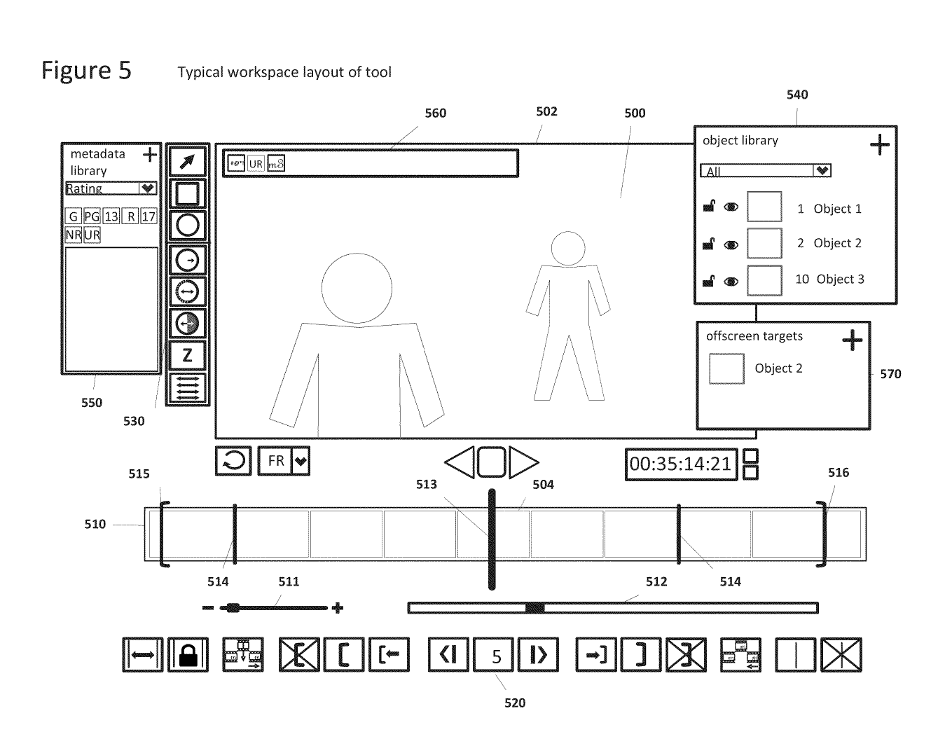

Given that the Object Dataset is created in reference to an underlying video, the user interface provides mechanisms for controlling the display of the video as well as features to create, review, and edit the Object Dataset associated with the video. FIG. 5 shows the functional areas of the user interface. A video playback area 502 provides display of a video 500 with controls directly below to activate the mode of playback of the video and monitor the time position of the current frame shown. Frames of the video 500 and current position are additionally represented in the timeline area 510, which can be zoomed with a zoom control 511 to show individual frames 504 of video or zoomed out to show a representation of the entire duration of the video. The zoom control 511 is represented as a slider on the lower left side of FIG. 5. In addition, the timeline area 510 can be scrolled with a scroll control 512 to show different regions of the timeline 510 at the current zoom level. The timeline 510 also contains a playhead 513, which resides over the frame of video currently displayed in the playback area 502. The playhead 513 can be dragged around the timeline 510, but the frame the playhead 513 is over always shows in the playback area 502. The timeline 510 also displays shot boundary indicators 514, which are vertical lines used to indicate the beginning and ending of a shot in the video 500. (A shot is a contiguous range of frames in the video 500 that are visually distinct from adjacent frames, and is usually created by one continuous movement of the camera shutter creating multiple frames.) Shot boundary indicators 514 can be added, moved, or deleted from the timeline 510. The timeline 510 also may display a mark-in marker 515 or a mark-out marker 516, or both a mark-in marker 515 and a mark-out marker 516 which indicate regions on the timeline that have been selected. Certain operations in the tool only affect selected frames in the timeline 510. If no markers are shown on the timeline 510, the shot that the playhead 513 resides in is the currently selected region.

Below the zoom control 511 and scroll control 512 under the timeline 510 are the timeline controls 520. These controls 520 allow the user to step through the video 500 forwards or backwards, set and delete markers, add, delete, and move shot boundary indicators, initiate the Span function, lock timeline regions, and insert or delete regions of bulk metadata.

Adjacent the left side of the playback area 502 is the toolbar 530, which contains tools for the following functions: selector, rectangle and ellipse drawing, orphan target, active/passive target, OnScreen/OffScreen target, Z-index, and autospan. These tools are primarily related to the creation and management of targets.

The object library 540 located to the upper right of the playback area 502 is where logical Objects are created and housed. They can be categorized, sorted, filtered, locked, and made invisible on the timeline and playback area. Objects have associated global traits, like ID number, name, color, etc., and temporal traits that are assigned from the metadata library 550, which is to the left of the toolbar 530. The metadata library 550 is where Traits are created and housed so that they may be readily assigned to Objects. The traits pane 560 is a horizontal bar on the upper left of the playback area 502 and is where specific traits assigned to an Object are displayed when present on the current frame of video 500 shown in the playback area 502.

The OffScreen targets pane 570 on the right side of the playback area 502 and below the object library 540 is where Targets appear representing Objects that are in the frame but not visually represented on the playback area.

The descriptions and diagrams of functional areas of the tool are presented for purposes of clarifying the general concepts of Object Dataset creation in the tool and do not represent the full depth of features and capability of the tool or its user interface.

### Object Dataset Creation Workflow:

Operations on an Object Dataset are performed through a project for that Object Dataset. The project is a stand-alone file containing all the data and user settings of the last saved work session on the Object Dataset. A project is established or opened in the tool.

The Object Dataset is normally created in reference to a specific video file. It is possible to proceed with operations to the Object Dataset without a reference video. A video is associated with the project via an import function. An associated video is not necessarily copied into the project but may be linked to the project from its current storage location. It is to be understood that multiple videos can be included in the project using the method and system disclosed herein. When a video is first associated with a project, the tool will analyze the video frames in the file and will extract relevant information useful to the operator regarding its format, frame rate, frame size, etc.

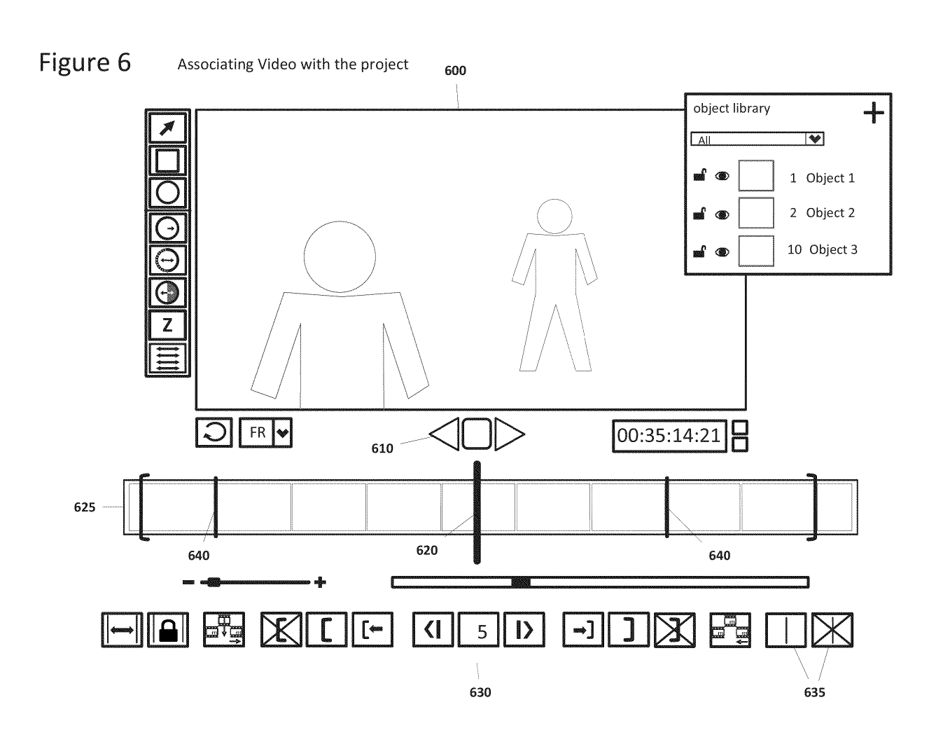

Referring to FIG. 6, the imported video appears in the playback area 600 of the tool where it can be viewed at various frame rates via the playback controls 610, scrolled through by dragging the playhead 620, or stepped through at various frame intervals on the timeline 625 using timeline controls 630. The tool will also create data configured to index the boundaries of each logical shot in the video. The shot boundaries 640 are represented as vertical lines on the timeline 625, and the operator can accept these boundaries or edit them using the shot boundary editing tools 635. Operations core to creating and managing Targets in the tool may be performed over one or more frames. A shot boundary reference 640 helps the operator efficiently assign the scope of an operation, as described more fully below.

As stated previously, an Object is a logical representation of an element that is visually, sonically, or conceptually present in a frame of video. For example, a visual element could be a pair of sunglasses or the face of a character wearing the sunglasses, or the chair on which the character is sitting. A sonic (or aural) element could be the sound of the waves coming from the off-screen ocean behind the character or the music playing during the particular scene, or even the character's dialog. A conceptual element is any bit of information present in the frame but not otherwise represented visually or sonically. An example of a conceptual element could be an actor who has walked off-screen in the current frame but is still considered present in the scene, or the content rating of the particular frame of video (e.g., it includes nudity or profanity) or any rights constraints on the frame of video, or even the fact that the frame of video is a particular time of day or setting. Any type of information that is not otherwise represented in the frame may be considered conceptual.

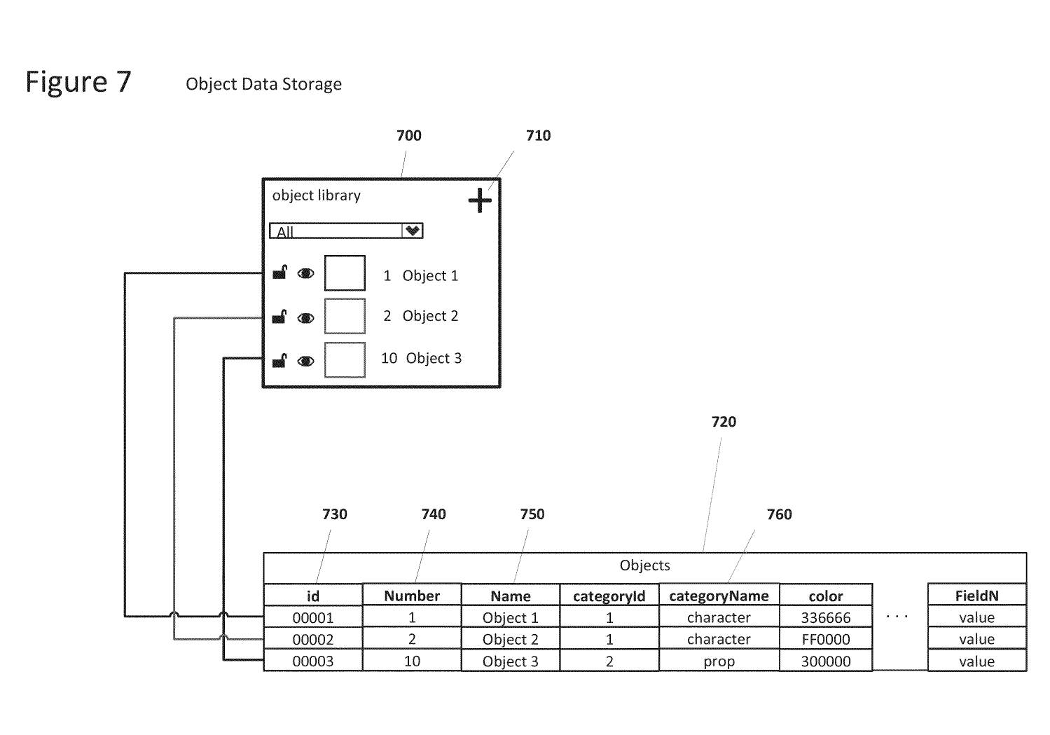

As represented in FIG. 7, Objects are created in an Object Library user interface 700 so that they can be searched and filtered for easy access. When a new Object is created in the library 700 by selecting the “Add Object” button 710, a corresponding record is created in the underlying Objects database table 720. Each Object in the Dataset is unique and is identified by its ID number 730. In addition to the ID number 730, an Object can carry any range of global Traits. Global Traits are descriptive data about the Object. For example, a user-assigned number 740 and name 750 for the Object, a category name for the Object 760, etc. This data depends on the type of Object. The Object for a character in the film might have the character's name, some descriptive information for the character—height, weight, age, etc. An Object for a prop, costume, product, or location would have different details.

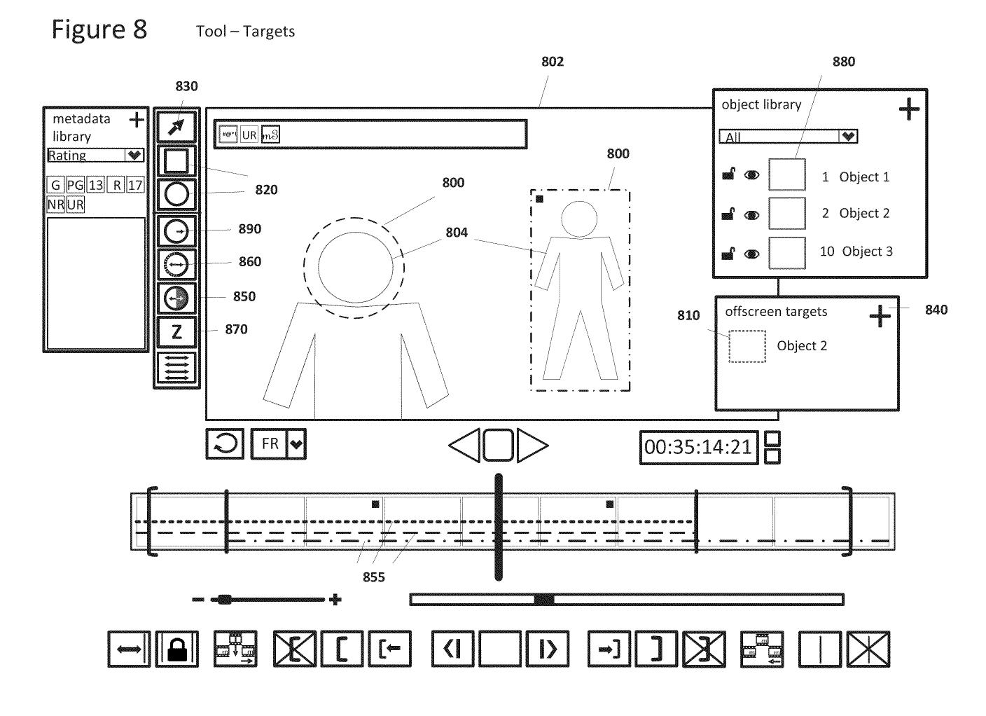

For an Object to be considered present in a frame of video, a Target associated with the Object must exist for the specific frame. As shown in FIG. 8, a Target is either a shape 800 that represents the visual area of the Object in the specific frame shown in the playback area 802, or a presence indicator 810 for the specific frame that indicates the Object is present in the frame shown in the playback area 802 either sonically or conceptually. A Target representing an on-screen Object is an OnScreen Target 800 and can be a basic shape (e.g., rectangle or ellipse) outlining the general boundaries of the Object's underlying visual element 804 shown in the playback area 802 or it can be a complex outline of the specific pixel boundary of the visual element 804 shown in the playback area 802. A Target representing an Object not represented visually in the playback area 802 is an OffScreen Target 810. The OffScreen Target 810 does not represent the shape boundaries of the Object, but the simple presence of the Object in the video frame.

OnScreen targets are created on a frame by using the rectangle and ellipse drawing tools 820 in the toolbar to the left of the playback area 802. Once created, they may be repositioned or reshaped using the selection tool 830 at the top of the drawing toolbar. OffScreen Targets are created either directly in the OffScreen targets pane by clicking the add target button 840 or by converting a currently selected OnScreen Target with the OnScreen/OffScreen Target toggle button 850. The existence of OnScreen or OffScreen Targets on a frame is also represented via Target presence indicators 855 on the timeline area of the user interface.

In addition to being OnScreen and OffScreen, a Target can be flagged at any time as being Active or Passive. An Active Target is one that is meant to be interacted with. A Passive Target is one that, although present in the frame, is not meant to be interacted with. Selected OnScreen and OffScreen Targets can be made Active or Passive using the Active/Passive Target toggle button 860. OnScreen Targets are assigned a Z axis order when created. This Z setting determines whether a Target that shares its spatial region with any other Target(s) is considered to be on top of or underneath the other Target(s) by the application logic of the tool. Z axis order is assigned to select Targets through the Z order button 870.

The primary purpose of a Target is to represent an Object's presence throughout the frames of the video. As such, a Target is normally associated with a specific Object by attaching the Object to the Target. This is accomplished by physically dragging an Object 880 from the object library onto an OnScreen Target 800 or an OffScreen Target 810. Likewise, Selected OnScreen or OffScreen Targets can be un-attached from any Object with the Orphan Target button 890. A Target may be re-attached to any Object at any time.

In addition to having global traits that do not change over time, Objects will most likely have temporal Traits. These are Traits that can change over the duration of the video on a per frame basis. In one set of frames a character might be running, in another they might be sitting. These states could be described through Temporal Traits. Another example of Temporal Traits could be the character's age throughout the film or even the changes in the clothes the character wears. Global and Temporal Traits can be assigned at any time after the Object is created. Both types of Traits are associated directly with an Object.

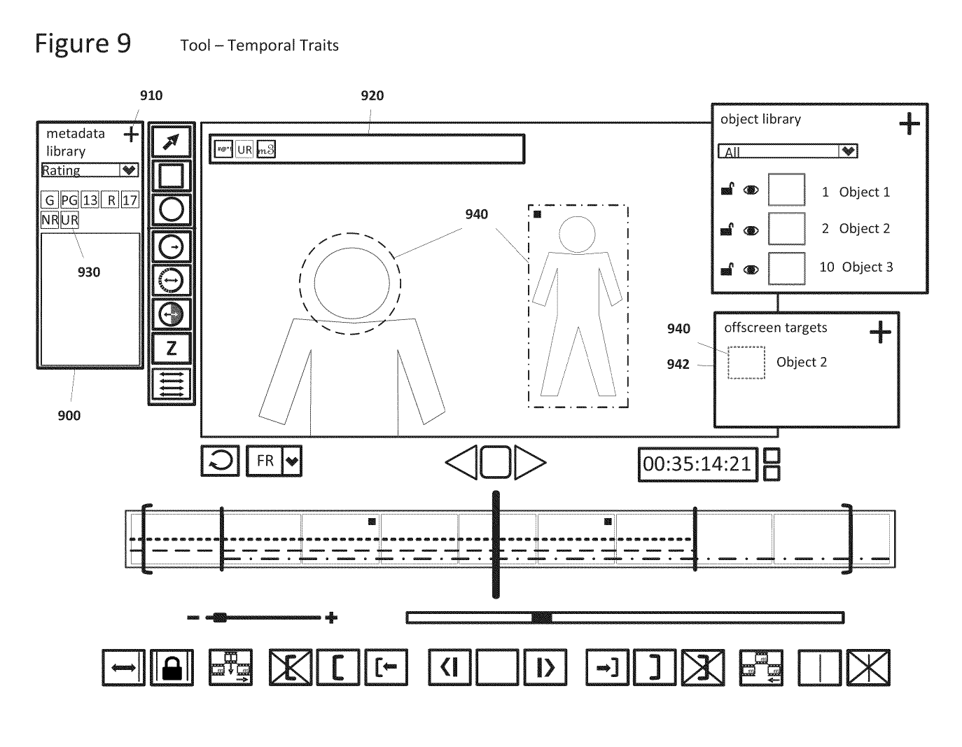

Global Traits can be created in the object library through an Object properties user interface. In FIG. 9, Temporal Traits are created in a metadata library 900 from which they can be easily assigned to one or more Objects. By selecting an Add Trait button 910 in the metadata library 900, a user interface for creating new Traits appears, allowing the user to create a category, sub-category, and value for the Trait and to import a representative icon image for the appearance of the Trait in the metadata library and Traits pane 920. Once a Trait is created in the library it can be searched, sorted, and filtered for easy access. It can also be assigned to multiple Objects without ever needing to be recreated in the metadata library. Assigning temporal Traits to an Object is accomplished by physically dragging the desired Trait icon 930 from the metadata library 900 to any Target 940 attached to the desired Object on screen or in the OffScreen Targets pane 942. Traits can be re-attached to other Objects by repeating this process.

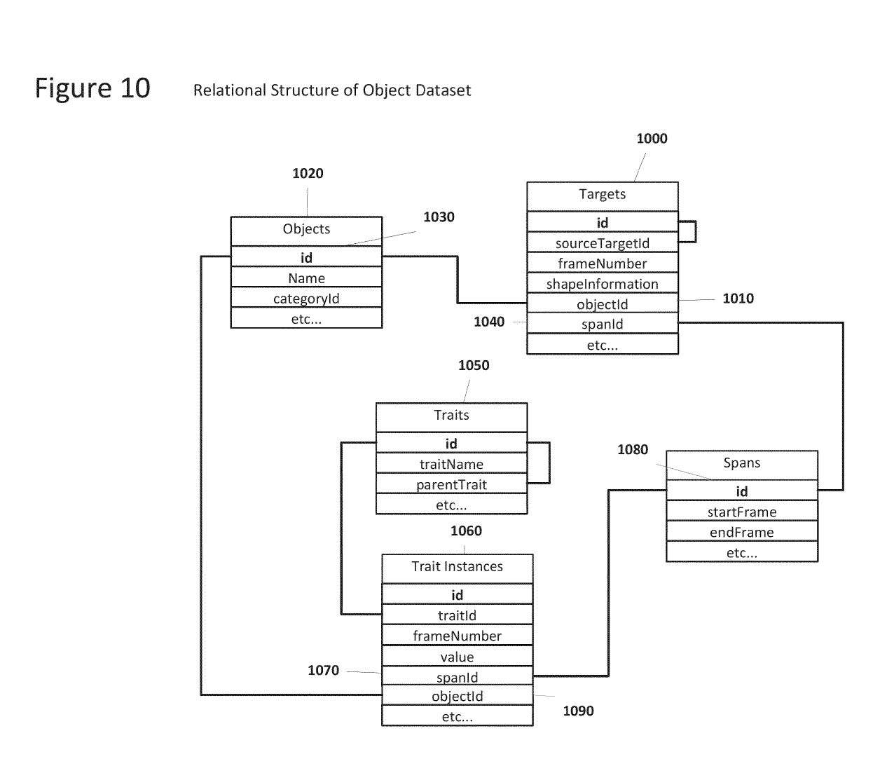

As with Objects, all information about Targets and Traits is stored in respective database tables. The relation of this information is key to the proper function of the Object Dataset. In FIG. 10, a Target record is represented by a Targets table 1000 and is linked via its objectId 1010 to a specific Object in the Objects table 1020 via the Object's unique ID 1030. The Target record also contains information determining what frames the Target is present on via its spanId 1040. Traits appearing in the metadata library are stored in an underlying Traits table 1050. A Trait from the library is attached to an Object via an instance in the Trait Instances table 1060. A Trait Instance record determines what frames the Trait is present on via its spanId 1070 relation to a specific Span record ID 1080. A Trait Instance is attached to an Object via its objectId value 1090.

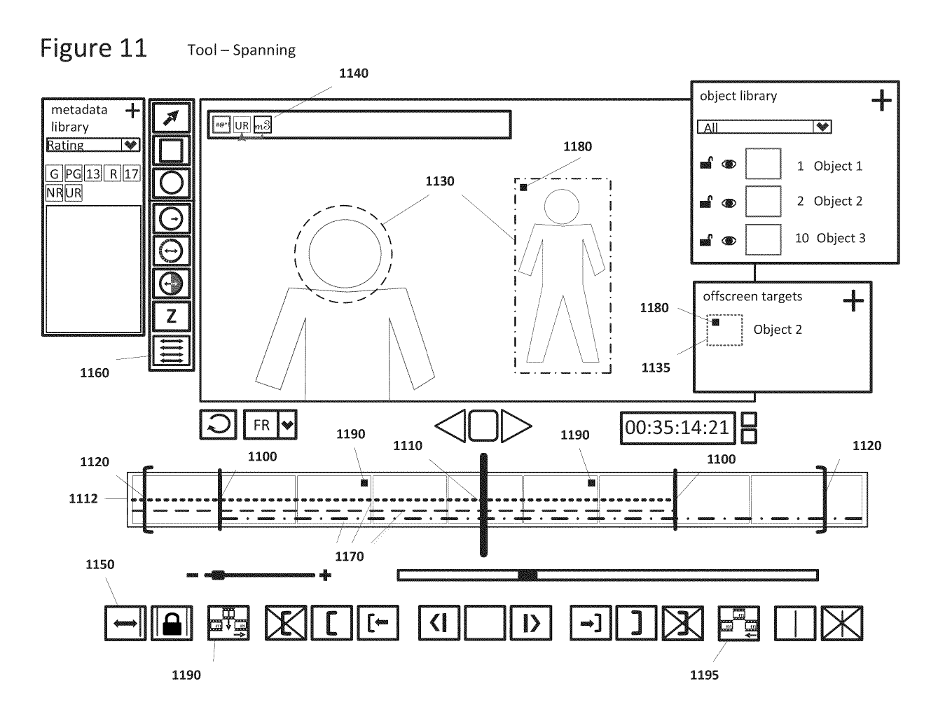

Once Targets or Traits or both have been assigned to an Object they can be copied across multiple frames of video. This is accomplished through the process of “Spanning.” Spanning is a method for copying metadata associated with one or several frames of video onto one or several other contiguous frames of video. In FIG. 11, by default, a Span operation affects only the frames in the current shot, that is, the region between two shot boundary indicators 1100 wherein the playhead 1110 resides on the timeline 1112. By setting one or more marks 1120 on the timeline 1112, the operator can alter the region to be Spanned. Once the desired region is selected on the timeline, Targets 1130 and 1135 or Traits 1140 or both that are to be Spanned are selected on the current frame. Spanning can be manually triggered with the Span button 1150 or the Span action can be set to automatically Span whatever action the operator performs in the currently selected region until the Span is deactivated. This is done by selecting the auto-Span button 1160.

When a Trait or OffScreen Target is Spanned, only a temporal association is created between the Trait/Target and the specific video frames that are Spanned. This is represented for each frame by presence indicators for Traits in the Traits pane 1140 and for OffScreen Targets 1135 in the OffScreen targets pane and by presence indicators 1170 on the timeline 1112. When an OnScreen Target 1130 is Spanned, in addition to the temporal association, spatial information describing the shape and position of the Target on each frame is Spanned. In the case that no other instance of the same Target already exists in the selected frames, the selected Target will simply be copied onto all the selected frames in the same shape, size, and position as the selected Target that has been Spanned. In the case that other instances of the same Target already exist on the selected frames, the position and shape of the Target will change per frame based on whatever method of auto-adjustment has been chosen. These auto-adjustments may consist of tweening, planar tracking, or other known methods of image tracking whose purpose is to automatically adjust for changes to the size, shape, and position of the Target to more accurately match the visual boundaries of the underlying visual element as it changes over time. OnScreen Targets are also represented on the timeline via presence indicators 1170 on each frame where the Target is temporally associated.

To assist the operator in determining which Targets have been previously Spanned, indicators 1180 appear on OnScreen Targets and OffScreen Targets and indicators 1190 appear as well on the timeline 1112. These indicators only appear on the original instance of a Target, called a Key Target, and they change color and/or shape depending on whether the Key Target has been Spanned or not. Key Targets that have been Spanned act as data references for all the Target instances resulting from the Span operation. Key Targets that have not been Spanned only exist as a single Target on a single frame. Target instances created as the result of a Span do not have these indicators unless the instance has been somehow individually changed in shape, position, size, or state, in which case the Target is then considered a Key Target.

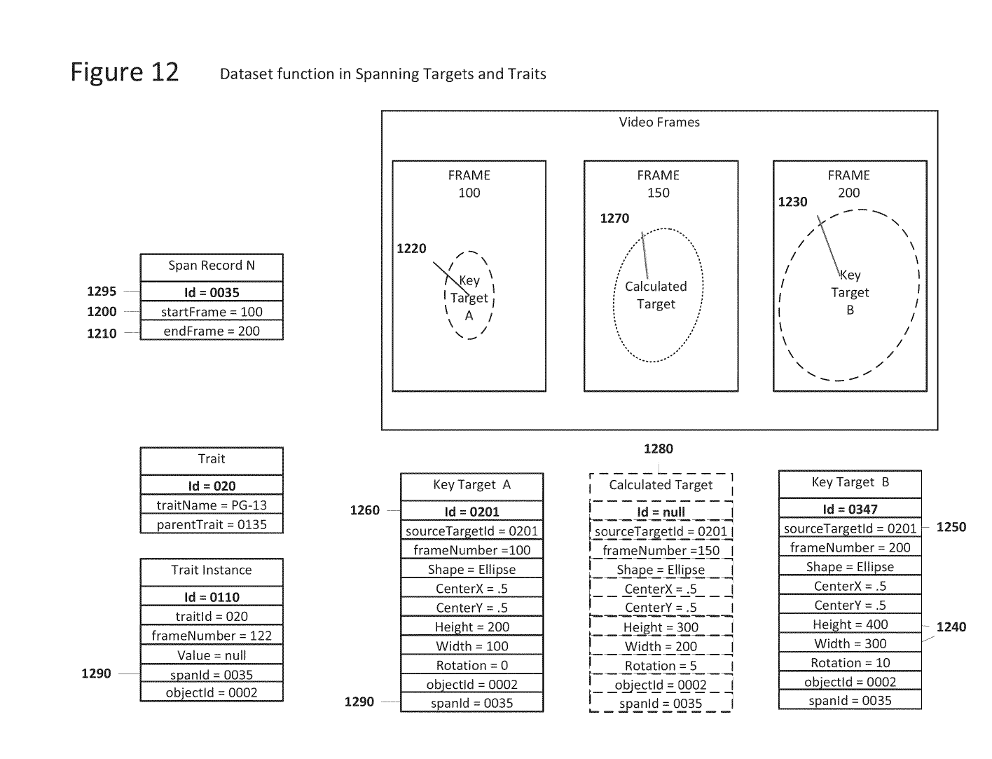

The method of calculating and storing information when Spanning Targets and Traits is illustrated in FIG. 12 and described more fully below. A span range from a startFrame of 100 1200 to an endFrame of 200 1210 has been selected. An OnScreen Key Target A 1220 exists on frame 100 of the video and an OnScreen Key Target B 1230, which was previously Spanned onto frame 200 of the video, has been modified manually such that its Height and Width are now 400 and 300 respectively, as shown at 1240. Because the Key Target B was initially created by Spanning Key Target A, it references the Key Target A through its sourceTargetld value 1250, which is the same as Key Target A's ID 1260. When the user selects either Key Target and initiates the Span operation, the tool calculates the appropriate data for all intermediate Targets in the Spanned region. These Calculated Targets 1270 do not persist in a database table, but are calculated based on whatever algorithm the tool is currently using for the Span operation. For example, in FIG. 12 the tool is using a simple tweening algorithm to determine the per frame differences in position, shape, and size of the Calculated Targets based on the differences in these values between Key Targets A and B. These differences are represented visually on the screen as well as in a temporary data record 1280 for the Calculated Target.

Although Spanning of Traits and OffScreen Targets does not involve spatial data calculations, the method of determining the Span range, presence on a frame, and state in the case of OffScreen Targets utilizes the same processes. When OffScreen Targets or Traits are Spanned, the currently selected startFrame 1200 and endFrame 1210 determine the range of frames the Target or Trait will be present on via a spanId value 1290 that references a specific Span record ID 1295 for the region Spanned. In addition, when an OffScreen Target is Spanned, its current state (e.g., Active/Passive, Attached/Orphan) also applies across all Calculated Targets in the Spanned region.

Once Objects, Targets, and Traits have been satisfactorily created for a video, the Object Dataset containing all this information exists within the project. In order to utilize an Object Dataset in another project or in an end-user media experience application, the Object Dataset must be exported into a consumable version of the data. Export of the Object Dataset is done via an export function in the tool. Object Datasets can be exported in their entirety or partially according to selected time region or selected data from the dataset. Further, the Object Dataset can be exported in the specific data format used by the tool or optionally into industry standardized forms of metadata according to the user's requirements.

Object Datasets can also be imported into a project in the tool. This importation can be a bulk replacement of any Object Dataset data that may have existed in a project or it can be a partial replacement. Within a project, metadata space can be created or deleted in the selected region of the timeline by using the Insert Empty Metadata Space button 1190 or the Delete Metadata Space button 1195 shown in FIG. 11.

### Consumption:

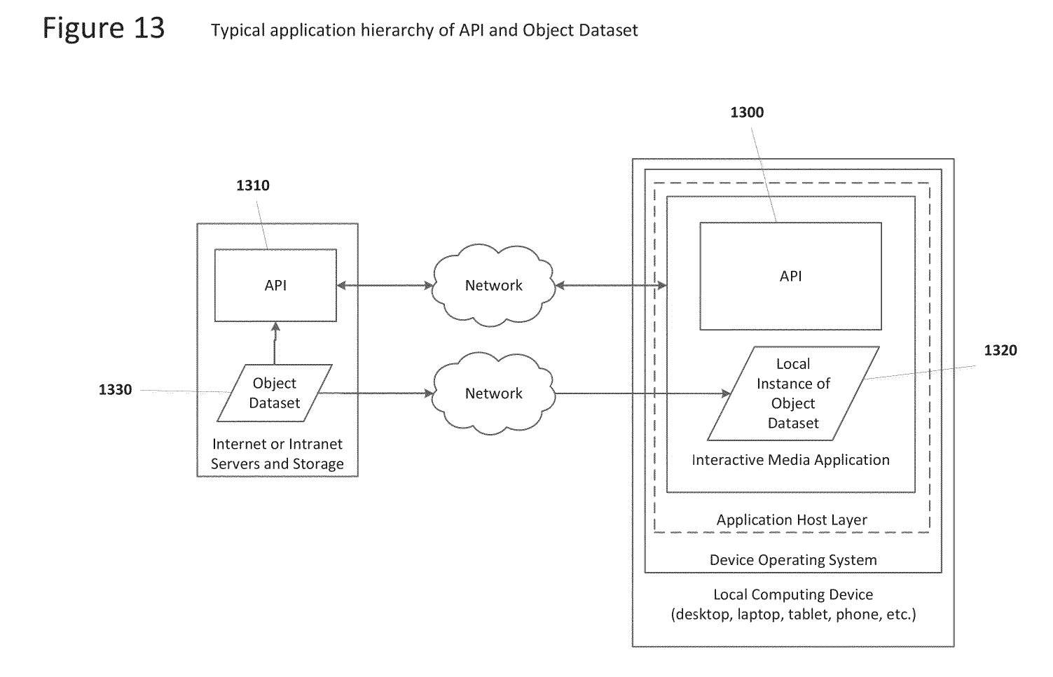

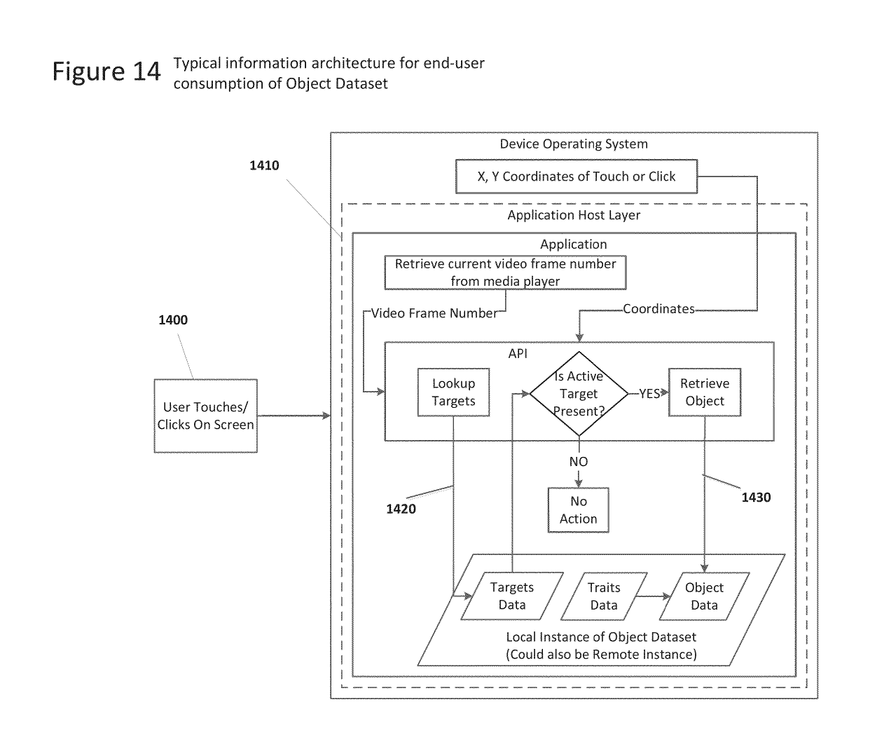

The following description is presented in conjunction with FIGS. 13 and 14. A media experience that includes Object-Based Interactivity needs to consume and process the delivered Object Dataset in such a way that interaction with the dataset either through user action or programmatic processes triggers the desired actions within the application.

Consumption of the Object Dataset within an end-user media application may be accomplished via an Application Programming Interface (API) in the form of software binaries and documentation provided with the Object Dataset that allows the application developers to easily query and receive data from the Object Dataset without having to directly interact with the Object Dataset. This layer of abstraction provides a faster method of developing the end-user media application. However, a developer may alternately choose to develop their own software method of extracting data from the Object Dataset when such dataset has been exported from the abovementioned tool in an industry standardized data format.

FIG. 13 shows the architecture of an end-user media application using the API binaries in combination with the Object Dataset to interact with the Object Dataset. As part of the application software program, the API binaries 1300 reside within the application and communicate with the application logic. Alternately, the API may reside partially or entirely as a network accessible resource 1310 such that requests are passed over the network and the API retrieves and transmits the appropriate Object Dataset information to the application. The Object Dataset may also reside locally in the application 1320 and may be updated or replaced by a network accessible version of the Object Dataset 1330.

In FIG. 14, when a user activates an exact position on the device screen by clicking or tapping on the screen 1400, the application will receive X, Y coordinate information from the device's OS, browser, or other system layer that the application is running on 1410. The application will also determine the time position or frame number of the video frame that was activated by the user. The application next passes on this information to the API, which polls the Object Dataset to determine what Objects were present on the activated frame. The API queries the Object Dataset to find if any active Targets are present in the current frame that intersect the given X,Y coordinates 1420. If an active Target exists, the Object Dataset returns the associated Object ID. Once the API knows the Object ID associated with the selected Target it then polls the Object Dataset to learn what specific Global and Temporal Traits are associated with the Object ID 1430. Using this information, the application can then apply logic to perform the specific tasks the application developer intended to be triggered by the specific Object Traits. The desired task may be simply to show a pop-over window displaying the name of the Object and a few other Traits, or it may be as complex as looking up the Object ID in an in-app store database and displaying the relevant Traits in the store so that users can conveniently purchase the item.

The Object dataset flow scenario above is an example of user-driven interactivity, but there are many cases where the media experience application will programmatically consume the Object Dataset to present the experience according to dynamic or pre-determined parameters. For example, if the application developer wanted to adjust the presentation of the video so that no shots that included nudity or profanity appeared, the application could poll the Object Dataset either in advance of starting playback or in real-time during playback. When frames were encountered with Objects that contained the Trait of “Nudity” or “Profanity” (or whatever Trait was relevant) the application would skip these frames or the entire shot or scene including the offending Objects. (If the Object Dataset is created with this particular use in mind, the experience can be predetermined such that the artistic quality of the edited version would be acceptable.) Another example of programmatic consumption of the Object Dataset could be automatically replacing Objects in the video based on contractual requirements or user preferences.

For example, a content owner might decide that consumers in a particular geographical area should be shown a can of Pepsi® in a particular scene rather than a can of Coke® as the character picks up the can and takes a drink. By polling the Object Dataset, the application could replace the visual image used in the video with a substitute—in this case, the image of the Pepsi® can rather than the Coke® can. If the spatial Target data for the Object was created with pixel boundary accuracy, then the replacement image could be swapped with the required artistic quality.

In general, the uniqueness of the media experience is dependent upon the scope and quality of the Object Dataset that has been created and how the media experience application chooses to consume the Object Dataset and trigger specific actions.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A computer-implemented method comprising:
receiving, by a configured computing system, at least one video frame;
determining, by the configured computing system, an element of interest in the at least one video frame;
creating a logical object to represent the element of interest;
assigning permanent and temporal descriptive traits from a prepopulated metadata library of permanent and temporal descriptive traits to the logical object;
creating, by the configured computing system, a target that represents an instance of the element of interest in the at least one video frame;
associating, by the configured computing system, the logical object with the target or the at least one video frame by using a logical link; and
storing, by the configured computing system, the logical object, the logical link, and the target to enable use of the assigned traits of the logical object upon a later user selection of the target.

2. The computer-implemented method of claim 1, further comprising creating the library of permanent and temporal descriptive traits to be associated with the logical object.

3. The method of claim 1 wherein the determining the element of interest in the at least one video frame and the creating of the target are performed based at least in part on human input.

4. The method of claim 1 wherein the determining of the element of interest in the at least one video frame and the creating of the target are performed in an automated manner without human input.

5. The method of claim 4 wherein the determining of the element of interest in the at least one video frame further includes determining the element of interest in multiple video frames, and wherein the creating of the target is performed for each of the determined multiple video frames, and wherein the logical object is associated with each created target.

6. The method of claim 1, further comprising, after the storing:
presenting the at least one video frame to a first user;
receiving an indication of a selection by the first user of a portion of the at least one video frame that corresponds to the target;
retrieving information included in the logical object associated with the target; and
in response to the selection by the first user, performing one or more additional automated operations based on the retrieved information.

7. The method of claim 1 wherein the creating the target further comprises creating a target that represents a visual outline of the element of interest in the at least one video frame.

8. A method comprising:
receiving, by a configured computing system, at least one video frame;
creating a logical object to represent an element of interest in the at least one video frame;
assigning permanent and temporal descriptive traits from a prepopulated metadata library of permanent and temporal descriptive traits to the logical object;
creating, by the configured computing system, a target that represents an instance of the element of interest in the at least one video frame;
associating, by the configured computing system, the logical object with the target or the at least one video frame by using a logical link;
receiving, by the configured computing system, a logical object, a logical link, a target, and an object trait associated with the received at least one video frame;
combining, by the configured computing system, the received at least one video frame with the associated logical object, logical link, target, and trait to produce an enhanced interactive video; and
selecting one or more targets associated with the at least one video frame from the enhanced interactive video.

9. The method of claim 8 wherein the logical object identifies at least one characteristic of the associated element of interest.

10. The method of claim 8, wherein the combining comprises associating the logical object with the object trait, the object trait including global and temporal traits, and storing a reference to the object trait in an object dataset.

11. The method of claim 8, further comprising:
receiving metadata;
associating the metadata with the logical object; and
storing a reference to the metadata in an object dataset.

12. The method of claim 8, further comprising:
outputting the object dataset in a visually discernable format.

13. A computing system, comprising:
a processor; and
a module that is configured to, when executed by the processor:
receive audiovisual content, the received content including indexed video frames;
associate a logical object with an element in at least one video frame of the received content;
identify video frames associated with the element;
create a target within each identified video frame, the target configured to represent an instance of the element in each identified video frame;
associate a logical object with the target or with an identified video frame; and
store a reference to each associated logical object and the target in an object dataset.

14. The computing system of claim 13 wherein the logical object is configured to identify at least one characteristic of its associated element.

15. A non-transitory computer-readable storage medium whose contents configure a computing system to perform a method, the method comprising:
managing a library of logical objects, the managing including:
receiving a request to update at least one logical object with supplied information; and
associating the supplied information with the at least one logical object;
managing a library of object traits, the managing including:
receiving a request to update at least one object trait with supplied information; and
associating the supplied information with the at least one object trait;
managing a library of metadata, the managing including:
receiving metadata;
receiving a request to associate the received metadata with at least one logical object; and
associating the received metadata with the at least one logical object;
managing a library of targets, the managing including:
receiving a request to associate target information with the at least one logical object, the target information including at least one identified region in at least one indexed video frame and an index of each at least one indexed video frame;
associating the target information with the at least one logical object;
correlating contents of the logical objects library, object traits library, metadata library and targets library; and
outputting the correlated contents to an object dataset.
